(19) United States
(12) Patent Application Publication
(10) Pub. No.: US 2005/0212237 A1
(43) Pub. Date: Sep. 29, 2005

(54) Wheelbarrow having an auxiliary rear wheel assembly

(76) Inventor: Paul Lin, Yung-Kang City (TW)

Correspondence Address: SAMPSON & ASSOCIATES, P.C., 50 Congress Street, Boston, MA, 02109, US

(21) Appl. No.: 10/837,816

(22) Filed: May 3, 2004

(30) Foreign Application Priority Data
Mar. 23, 2004 (TW) 93204408

(51) Int. Cl. B62K 13/00

(52) U.S. Cl. 280/47.31

(57) ABSTRACT

A wheelbarrow includes a frame, a container, a front wheel assembly, an auxiliary rear wheel assembly, and a connecting unit. The frame includes a seat, two wheel support arms for mounting of the front wheel assembly, and a leg unit extending downwardly from the seat. The container is fixed on top of the seat. The auxiliary rear wheel assembly includes a shaft and two auxiliary rear wheels journalled respectively on two opposite ends of the shaft. The connecting unit connects the shaft to the leg unit, and permits the shaft to be detached from the frame.

### BACKGROUND OF THE INVENTION

1. Field of the Invention

The invention relates to a wheelbarrow, more particularly to a wheelbarrow having an auxiliary rear wheel assembly.

2. Description of the Related Art

Referring to FIG. 1, a conventional powered wheelbarrow includes abase seat 21, a container 22 fixed on top of the base seat 21, two handles 212 extending rearwardly from the base seat 21, an electrically operated wheel 23 incorporating a motor and installed at a front lower part of the base seat 21, and a power unit 24 fixed on a bottom portion of the base seat 21 for actuating rotation of the wheel 23. The power unit 24 may include a storage battery. Alternatively, in place of the power unit 24 and the electrically operated wheel 23, an engine in combination with a chain-and-wheel driving mechanism may be used to drive rotation of a wheel.

The base seat 21 is supported on the ground by the wheel 23 and two support legs 211 that project downwardly and respectively from two sides of the base seat 21. The load to be transported is received in the container 22.

To propel the wheelbarrow, the handles 212 are lifted first so as to raise the support legs 211 above the ground such that only the wheel 23 touches the ground. Then, a lever 213 provided on one of the handles 212 is pressed thereby enabling transmission of electric power from the power unit 24 to the wheel 23, which in turn activates the wheel 23 to rotate for moving the wheelbarrow forward. As such, the operator does not have to push the wheelbarrow.

Although the aforementioned conventional powered wheelbarrow can achieve its intended purpose, under some circumstances, lifting the handles 212 would require a large effort from the operator, especially when transporting the load through a steep terrain.

### SUMMARY OF THE INVENTION

Therefore, the object of the present invention is to provide a wheelbarrow that can overcome the aforesaid drawback of the prior art.

According to this invention, a wheelbarrow comprises a frame, a container, a front wheel assembly, an auxiliary rear wheel assembly, and a connecting unit. The frame includes a seat, two wheel support arms extending frontwardly and inclining downwardly from the seat, two spaced-apart handle members extending rearwardly and upwardly from the seat, and a leg unit extending downwardly from the seat at a rear side of the wheel support arms. The container is fixed on top of the seat. The front wheel assembly is mounted on the wheel support arms. The auxiliary rear wheel assembly includes a shaft, and two auxiliary rear wheels journalled respectively on two opposite ends of the shaft. The connecting unit connects the shaft to the leg unit, and permits the shaft to be detached from the frame.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional powered wheelbarrow;

FIG. 2 is a perspective view of the first preferred embodiment of a powered wheelbarrow according to the present invention;

FIG. 3 is a schematic side view of the first preferred embodiment;

FIG. 4 is a fragmentary enlarged schematic view of the first preferred embodiment, illustrating how a horizontal shaft can be clamped detachably against a leg unit and a connecting unit; and

FIG. 5 is a view substantially similar to FIG. 4, but illustrating the second preferred embodiment of a powered wheelbarrow according to the present invention.

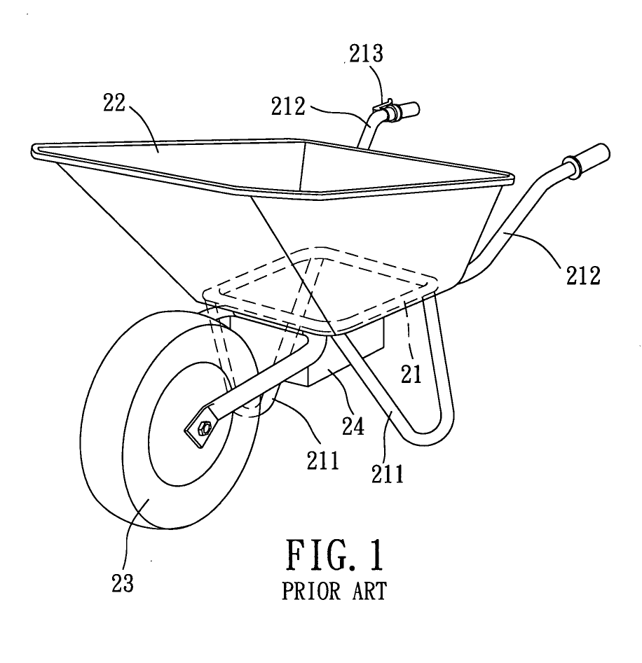

### DETAILED DESCRIPTION OF THE PREFERRED EMBODIMENTS

Before the present invention is described in greater detail, it should be noted that like elements are denoted by the same reference numerals throughout the disclosure.

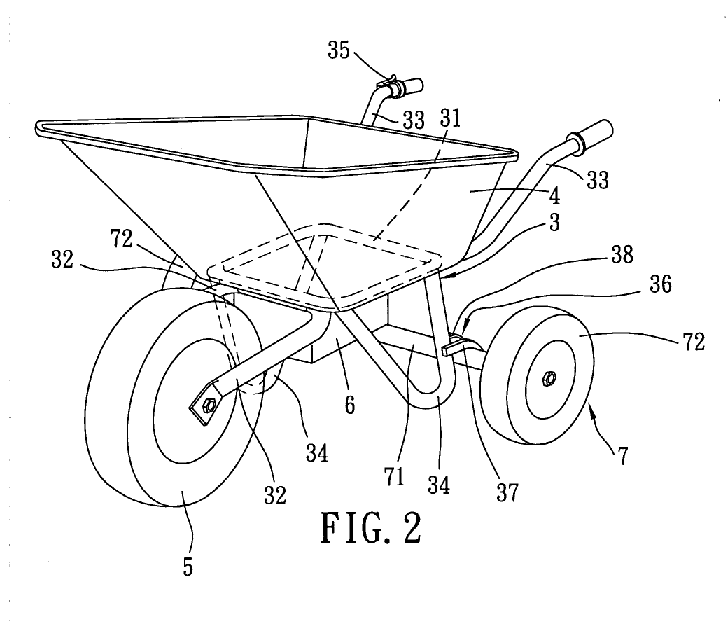

Referring to FIGS. 2 to 4, the first preferred embodiment of a powered wheelbarrow according to the present invention is shown to include a frame 3, a container 4, a front wheel assembly 5, a power unit 6, and an auxiliary rear wheel assembly 7.

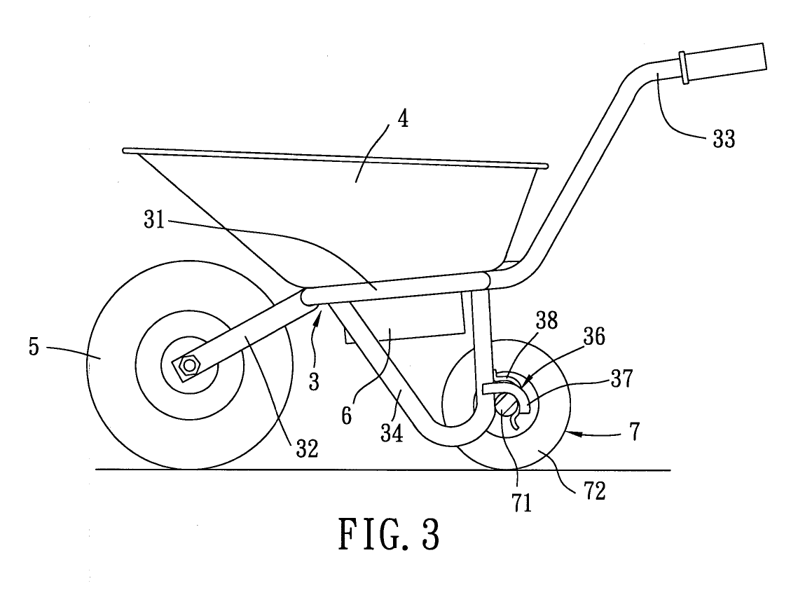

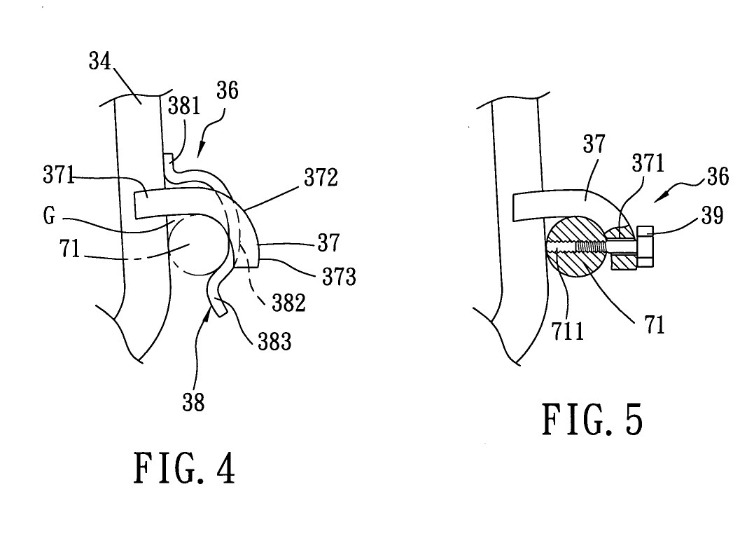

The frame 3 includes a flat rectangular seat 31, two spaced-apart wheel support arms 32 extending frontwardly and inclining downwardly from the seat 31, two spaced-apart handle members 33 extending rearwardly and upwardly from the seat 31, and a leg unit having two supporting legs 34 extending downwardly and respectively from two opposite sides of the seat 31 at a rear side of the wheel support arms 32. Two connecting units 36 are disposed respectively on the supporting legs 34. However, only one connecting unit 36 is visible in FIGS. 2 and 3. Each of the connecting units 36 includes a retaining hook 37 and an elastic clamping unit 38 that are fixed on an appropriate height of a respective one of the supporting legs 34 and that are disposed side-by-side. Each retaining hook 37, as best shown in FIG. 4, has a fixed end 371 connected to a side surface of the respective supporting leg 34, and a curved portion 372 extending rearwardly and downwardly from the fixed end 371. The curved portion 372 has a free end 373 opposite to the fixed end 371. Each clamping unit 38 includes a substantially C-shaped intermediate portion 382, and upper and lower end portions 381, 383 that are substantially L-shape and that are connected respectively to two opposite ends of the intermediate portion 382. The upper end portion 381 is connected to and extends outwardly from a rear surface of the respective supporting leg 34 proximate to the fixed end 371, and the lower end portion 383 is separate from the respective supporting leg 34. As shown in FIG. 4, a gap (G) is formed between the curved portion 372 and the respective supporting leg 34.

The container 4 is fixed on top of the seat 31 of the frame 3, and has a top opening.

The power unit 6 is fixed on a bottom portion of the seat 31 of the frame 3. In this embodiment, the power unit 6 is exemplified as including a storage battery, and the front wheel assembly 5 is motor-driven. A lever 35 is provided on one of the handle members 33 in a conventional manner for controlling activation of the power unit 6.

The front wheel assembly 5 is connected to and is disposed between the wheel support arms 32 of the frame 3, and is actuated by the power unit 6 to rotate.

The auxiliary rear wheel assembly 7 includes a shaft 71 connected detachably to the frame 3, and two auxiliary rear wheels 72 journalled respectively on two opposite ends of the shaft 71 so as to raise the support legs 34 above the ground.

When installing the auxiliary rear wheel assembly 7, the retaining hooks 37 and the clamping units 38 of the connecting units 36 are placed above the shaft 71, and are then pressed against the shaft 71. During this time, the shaft 71 is forced to enter the gaps (G) (only one is shown in FIG. 4) defined by the connecting units 36 and the supporting legs 34 through the lower end portions 383 of the clamping units 38, after which the intermediate portion 382 of each clamping unit 38 clamps the shaft 71 against the corresponding curved portion 372 and the corresponding supporting leg 34, as best illustrated in FIG. 4. Because the clamping units 38 clamp resiliently the shaft 71 against the curved portions 372 and the respective supporting leg 34, undesired removal of the shaft 71 from the connecting units 36 is prevented. Furthermore, a limiting unit, such as a pin or a sleeve (not shown), may be provided on the shaft 71 so as to prevent axial movement of the shaft 71 relative to the supporting legs 34. However, if the length of the shaft 71 is substantially equal to the distance between the connecting units 36, because the auxiliary rear wheels 72 are journalled on the shaft 71, axial movement of the shaft 71 is limited by the connecting units 36 so that the aforementioned limiting unit is not necessary.

If the auxiliary rear wheel assembly 7 is not required, since the clamping units 38 are resilient, the shaft 71 can be moved downwardly so as to release the same from the intermediate and lower end portions 382, 383 of the clamping units 38, thereby detaching the auxiliary rear wheel assembly 7 from the frame 3.

The powered wheelbarrow of the present invention can rest on the ground through the front wheel assembly 5 and the auxiliary rear wheels 72, which form a triangular configuration to support the wheelbarrow stably on the ground, after which the load to be transported can be loaded into the container 4. To move the wheelbarrow forward, the lever 35 is operated in order to enable transmission of power from the power unit 6 to the front wheel assembly 5. The front wheel assembly 5 is thus activated, which brings the auxiliary rear wheels 72 to rotate and moves the wheelbarrow forward. Accordingly, the operator does not have to push the wheelbarrow of the present invention to move the same forward, and does not have to lift the handle members 33. Therefore, even if the gradient of a slope terrain is steep, the powered wheelbarrow of the present invention can be rolled easily.

Dumping of the load from the container 4 is accomplished in a conventional manner. That is, the operator lifts the handle members 33 with the auxiliary rear wheel assembly 7 raised from the ground and with only the front wheel assembly 5 touching the ground.

Referring to FIG. 5, the second preferred embodiment of a powered wheelbarrow according to the present invention is shown to be substantially similar to the first preferred embodiment. However, in this embodiment, the shaft 71 is provided with two diametrically extending screw holes 711 (only one is shown) formed in two opposite ends thereof. Each connecting unit 36 includes a retaining hook 37, and a screw 39 that extends through a through hole 371 in the retaining hook 37 and that engages threadedly a respective one of the screw holes 711 so as to connect detachably the shaft 71 to the respective supporting leg 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A wheelbarrow comprising:
a frame including a seat, two wheel support arms extending frontwardly and inclining downwardly from said seat, two spaced-apart handle members extending rearwardly and upwardly from said seat, and a leg unit extending downwardly from said seat at a rear side of said wheel support arms;
a container fixed on top of said seat;
a front wheel assembly mounted on said wheel support arms;
an auxiliary rear wheel assembly including a shaft, and two auxiliary rear wheels journalled respectively on two opposite ends of said shaft; and
a connecting unit that connects said shaft to said leg unit and that permits said shaft to be detached from said frame.

2. The wheelbarrow as claimed in claim 1, wherein said connecting unit includes a retaining hook having a fixed end connected to said leg unit and a curved portion extending rearwardly and downwardly from said fixed end, said curved portion having a free end opposite to said fixed end, said shaft being disposed between said curved portion and said leg unit.

3. The wheelbarrow as claimed in claim 2, wherein said connecting unit further includes an elastic clamping unit that clamps resiliently said shaft against said curved portion and said leg unit.

4. The wheelbarrow as claimed in claim 3, wherein said clamping unit includes a substantially C-shaped intermediate portion, and upper and lower end portions connected respectively to two opposite ends of said intermediate portion, said upper end portion being fixed to said leg unit proximate to said fixed end, said lower end portion being separate from said leg unit, said intermediate portion clamping said shaft against said curved portion and said leg unit.

5. The wheelbarrow as claimed in claim 2, wherein said shaft is provided with a diametrically extending screw hole, said connecting unit further including a screw that extends through said retaining hook and that engages threadedly said screw hole so as to connect detachably said shaft to said leg unit.
